(19) United States
(12) Patent Application Publication
(10) Pub. No.: US 2008/0006131 A1
(43) Pub. Date: Jan. 10, 2008

(54) Apparatus for Cutting Fruit Into Slices and Dispensing the Slices

(76) Inventor: Timothy Robert Jones, Swansea (GB)

Correspondence Address: Iandiorio & Teska, 260 Bear Hill Road, Waltham, MA, 02451, US

(21) Appl. No.: 11/791,155

(22) PCT Filed: Nov. 25, 2005
(86) PCT No.: PCT/GB05/04526

§ 371 Date: May 18, 2007

(30) Foreign Application Priority Data
Dec. 8, 2004 (GB) 0426935.3

(51) Int. Cl. B26D 1/08

(52) U.S. Cl. 83/257; 83/651

(57) ABSTRACT

Apparatus (2) for cutting fruit (4) into slices (6) and dispensing the slices (6), which apparatus (2) comprises a cutting station (8) at which the fruit (4) is cut into the slices (6), a holder (10) which is for the fruit (4) to be cut and which extends vertically above the cutting station (8), a cutting blade (12) which extends at right angles to the holder (10) and which is movable forwards and rearwards over the cutting station (8), and dispenser means (14) for retaining the fruit (4) to be cut at the cutting station (8) and dispensing the cut slices (6), the dispenser means including a platform portion (28) which supports the fruit (6) to be cut at the cutting station (8) and in the holder, the platform portion (28) and the dispensing aperture (16) being both provided in a flat member (30), the platform portion (28) being positioned forwardly of the dispensing aperture (16), and the apparatus (2) being such that the cutting blade (12) is moved forwards over the cutting station (8) by hand pushing in order to effect the cutting of the fruit (4) into the slices (6), the cutting blade (12) cuts the slices (6) one at a time, and the dispenser means (14) comprises a dispensing aperture (16) through which the out slices (6) fall.

This invention relates to apparatus for cutting fruit and, more especially, this invention relates to apparatus for cutting fruit into slices and dispensing the slices.

Fruit such for example as lemons and oranges is often cut into slices and placed into drinks for the purpose of flavoring the drinks. The fruit can be cut into slices all at the same time and the slices stored for use. However if the slices are not used reasonably quickly, they lose their fresh look and may appear dried on the surface. The slices can be cut from the fruit one at a time using a cutting knife. This may not always be convenience in busy areas, for example behind bars in public houses at peak serving times. In addition, the fruit needs to be cut on a cutting block, which means that both the knife and the cutting block will usually become wet with fruit juice from the fruit. For purposes of hygiene, the knife and the cutting block need to be cleaned if the next fruit slice is not to be cut substantially immediately. Again such cleaning is not always convenient or possible in busy situations.

It is an aim of the present invention to reduce the above mentioned problems.

Accordingly, in one non-limiting embodiment of the present invention there is provided apparatus for cutting fruit into slices and dispensing the slices, which apparatus comprises a cutting station at which the fruit is cut into the slices, a holder which is for the fruit to be cut and which extends vertically above the cutting station, a cutting blade which extends at right angles to the holder and which is movable forwards and rearwards over the cutting station, and dispenser means for retaining the fruit to be cut at the cutting station and dispensing the cut slices, the dispenser means including a platform portion which supports the fruit to be cut at the cutting station and in the holder, the platform portion and the dispensing aperture being both provided in a flat member, the platform portion being positioned forwardly of the dispensing aperture, and the apparatus being such that the cutting blade is moved forwards over the cutting station by hand pushing in order to effect the cutting of the fruit into the slices, the cutting blade cuts the slices one at a time, and the dispenser means comprises a dispensing aperture through which the cut slices fall.

The apparatus of the present invention is of a simple construction which is operable by hand. A drive motor is not required for operating the cutting blade and thus the apparatus of the present invention is able to be more cheaply constructed, lighter and easier to clean than would be the case if a motor were required for driving the cutting blade. The apparatus can be used to cut the fruit into the slices as and when required. The apparatus can be used with a good degree of hygiene since the fruit to be cut is retained in the holder, and also since the cut slices are able to fall through the dispensing aperture without the need to be touched by hand.

Preferably, the apparatus is one in which the cutting blade and the dispenser means are mounted on a movable support member.

The movable support member may include a pair of guide rods which are positioned one on either side of the apparatus, and which extend through guide apertures on either side of the apparatus.

The movable member may include a handle for facilitating the forwards movement of the cutting blade.

The apparatus may be one in which the flat member is positioned below and spaced apart from the cutting blade, and in which the dispensing aperture is arranged to be beneath the fruit to be cut at the time when the cutting blade finishes its cutting action, whereby the cut slice is able to drop directly through the dispensing aperture. With such an arrangement, there is direct and immediate dispensation of the cut slice. There is no need for the cut slice to be touched. The dispensation is thus always hygienic and the cut slice is always freshly cut.

Preferably, the cutting blade is moved rearwards over the cutting station by spring biasing means. The rearwards movement is thus automatic and the apparatus is then always ready for the next use. Alternatively, if desired, the cutting blade may be manually pulled back for a next use.

When the apparatus includes the guide rods, then the biasing means may comprise a pair of coil springs mounted one on each of the pair of guide rods.

Preferably, the cutting blade has a cutting edge which extends at an angle to a longitudinal axis of the cutting blade. The cutting blade will usually also be a very thin cutting blade. With the combination of the angled cutting edge and the very thin cutting blade, the fruit is cut neatly and cleanly into the slices.

The apparatus may be one in which the cutting blade has a bottom face which is provided with guide means for guiding the cut slices away from the bottom face of the blade, whereby the cut slices are not able to stick to the bottom face of the blade. The guide means may be at least one wedge. Preferably, there are two of the wedges. The guide means may be in shapes other than a wedge shape.

The apparatus of the invention may include mounting means for mounting the apparatus to a vertical support surface such for example as wall. Alternatively, the apparatus may include mounting means for mounting the apparatus to a horizontal support surface such for example as a work surface.

The apparatus is preferably constructed for being dismantled for washing purposes. Thus, for example, the apparatus may have parts which pull off and clip back into place. One such part may be the holder for the fruit to be cut. The holder may be detachable from the cutting station for the purpose of providing easy access to the cutting station for cleaning, and also for the purpose of enabling easy access to the holder for cleaning and/or fruit loading.

The apparatus may be constructed from plastics materials for ease of washing and keeping the apparatus clean. The blade will usually be made of stainless steel or some other material which is not affected by juices from the cut fruit. Generally the blade may be made from the same materials that are used to make knives.

An embodiment of the invention will now be described solely by way of example and with reference to the accompanying drawings in which:

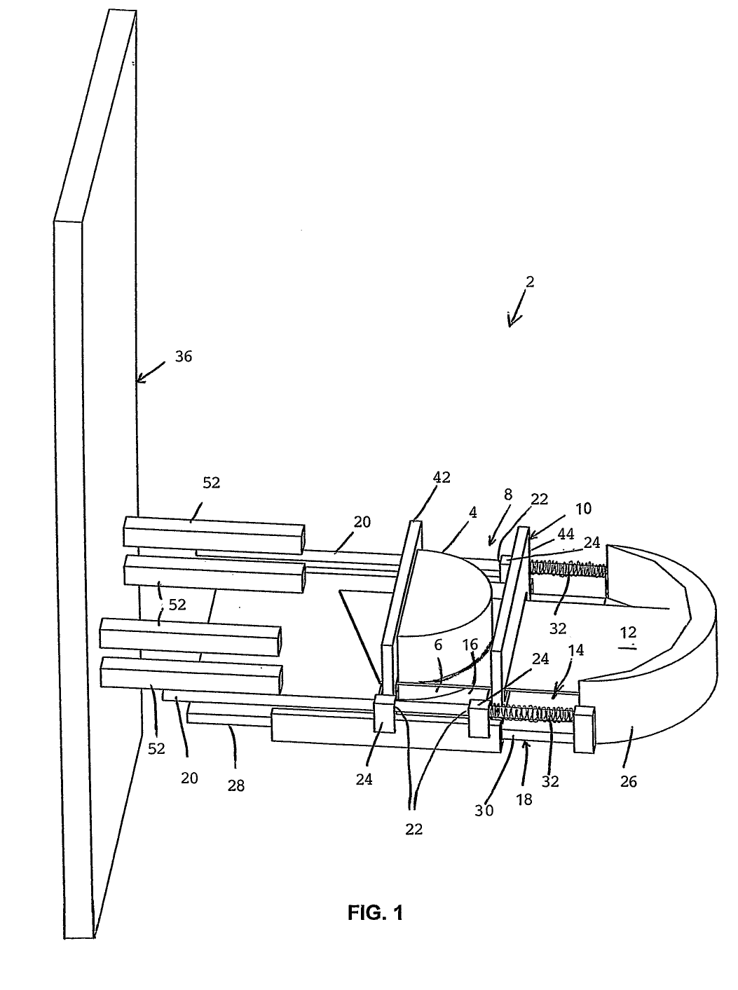

FIG. 1 is a perspective view from above and one side of part of apparatus of the invention in use and just having completed a cutting stroke;

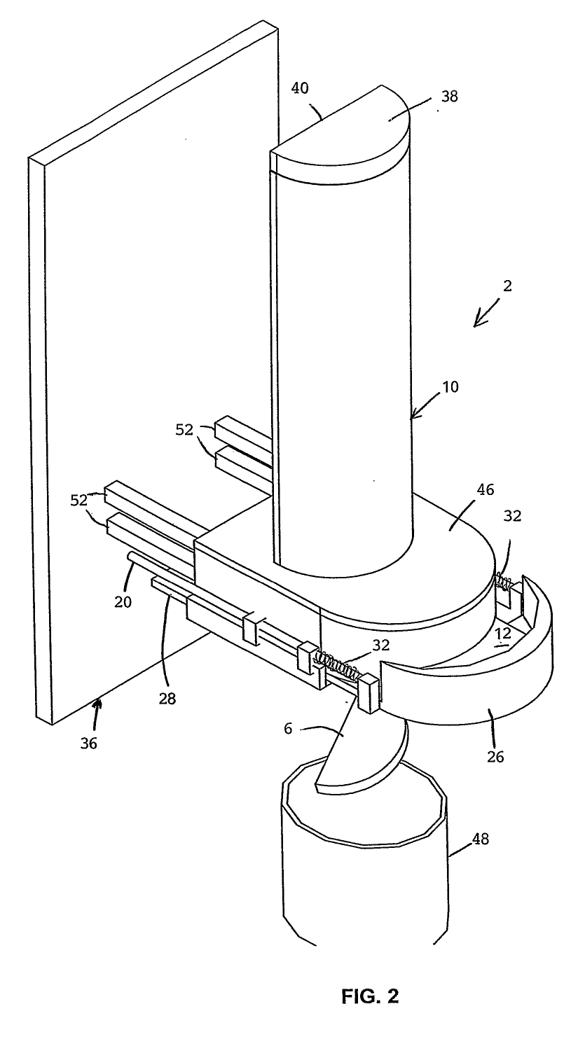

FIG. 2 is a perspective view from above, the rear and one side of the entire apparatus in the position shown in FIG. 1;

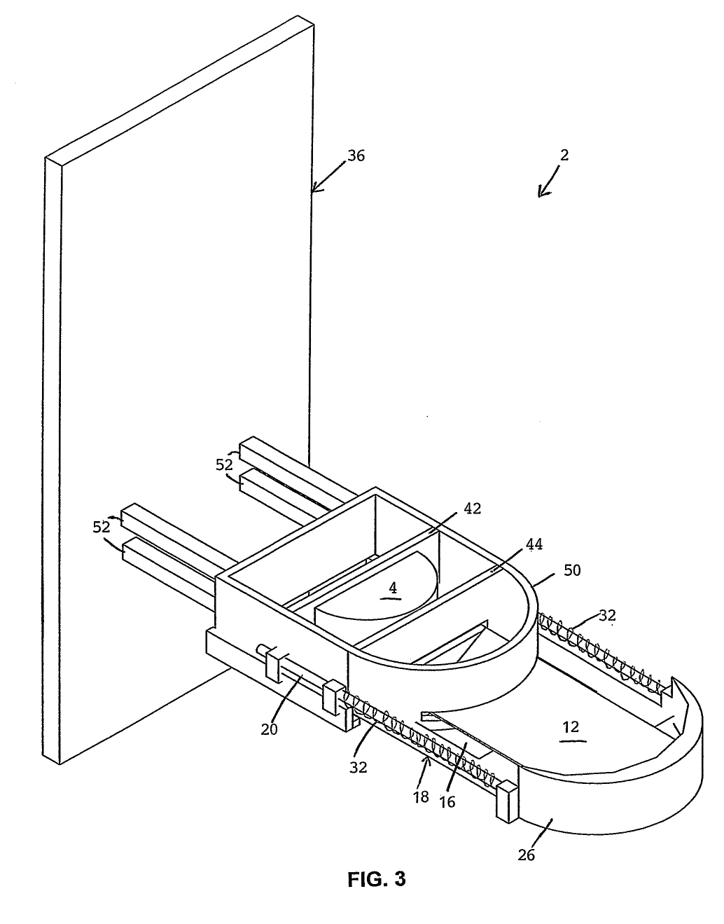

FIG. 3 shows the part of the apparatus shown in FIG. 1 but with the apparatus having been returned to its ready-for-operation position;

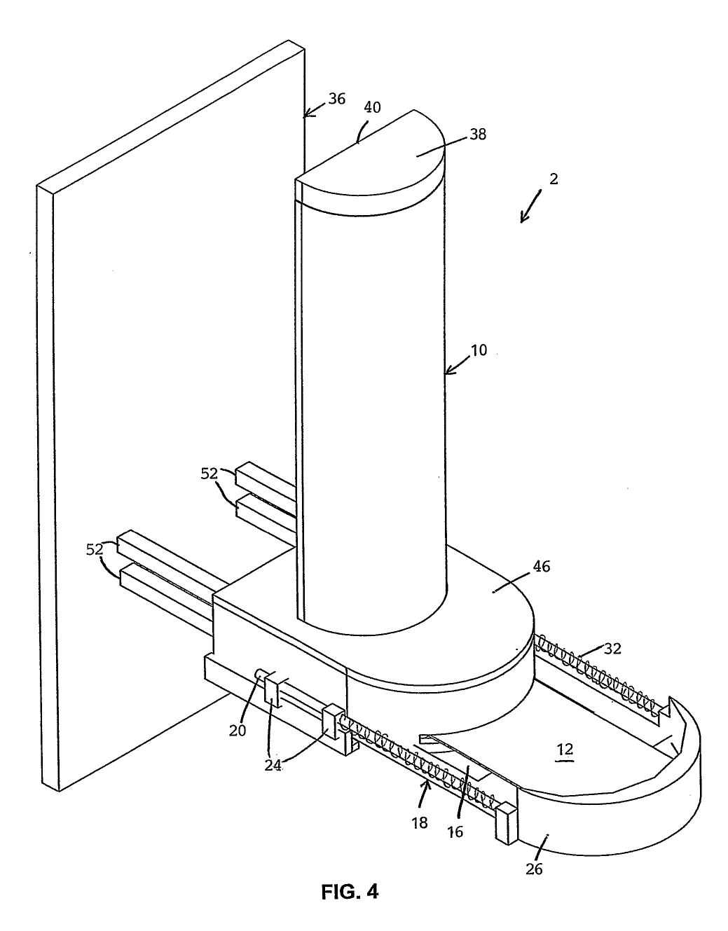

FIG. 4 is a view like FIG. 2 but with the apparatus being in the position shown in FIG. 3; and

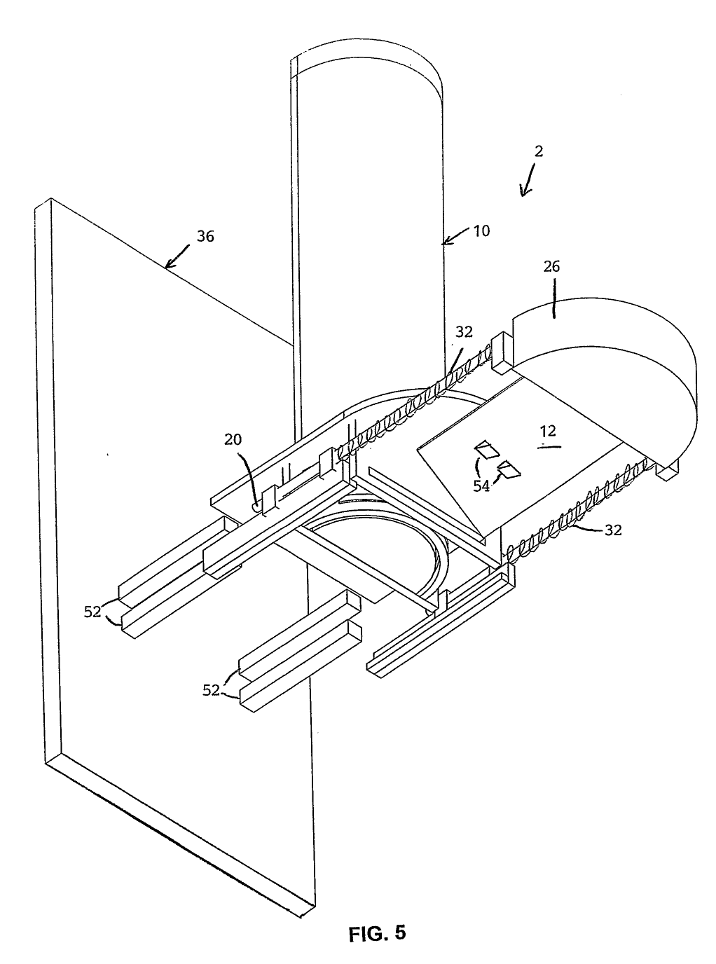

FIG. 5 is a perspective view from underneath of the apparatus.

Referring to the drawings, there is shown apparatus 2 for cutting fruit 4 into slices 6 and dispensing the slices 6. The apparatus 2 comprises a cutting station 8 at which the fruit 4 is cut into the slices 6. The apparatus 2 also comprise a holder 10 which is for the fruit 4 to be cut, and which extends vertically above the cutting station 8.

A cutting blade 12 extends at right angles to the holder 10 and is movable forwards and rearwards over the cutting station 8. Dispenser means 14 is provided for retaining the fruit 4 to be cut at the cutting station 8, and for dispensing the cut slices 6.

The apparatus 2 is such that the cutting blade 12 is moved forwards over the cutting station 8 by hand pushing in order to effect the cutting of the fruit 4 into the slices 6. The cutting blade 12 cuts the slices 6 one at a time. The dispenser means 14 comprises a dispensing aperture 16 through which the cut slices 6 fall.

The cutting blade 12 and the dispenser means 14 are mounted on a movable support member 18. The movable support member 18 includes a pair of guide rods 20 which are mounted one on either side of the apparatus 2 as shown. The guide rods 20 extend through guide apertures 22 in guide blocks 24 which up stand from the support member 18 as shown.

The movable support member 18 includes a handle 26 for facilitating the forwards movement of the cutting blade 12. The handle 26 is a curved as shown. The handle 26 is made of a plastics material and the cutting blade 12 is embedded into the handle 26.

The dispenser means 14 includes a platform portion 28 which supports the fruit 4 to be cut at the cutting station 8 and in the holder 10. The platform portion 28 and the dispensing aperture 16 are both provided in a flat member 30. The flat member 30 forms part of the support member 18. The platform portion 28 is positioned forwardly of the dispensing aperture 16. The flat member 30 is positioned below and spaced apart from the cutting blade 12. The dispensing aperture 16 is arranged to be beneath the fruit 4 to be cut at the time when the cutting blade 12 finishes its cutting action. The cut slice 6 is then able to drop directly through the dispensing aperture 16. The dispensation of the cut slice 6 is thus direct and immediate. There is no need to touch the cut slice 6. The slice 6 can be cut as and when desired so that it is always dispensed hygienically and in a fresh condition.

The cutting blade 12 is moved rearwardly over the cutting station 8 by spring biasing means. The rearward movement can be appreciated by comparing FIGS. 1 and 3. In FIG. 1, it will be seen that the cutting blade 12 has been moved forwards to effect a cutting action. In FIGS. 3 and 4, it will be seen that the cutting blade 12 has been moved rearwards to be ready for the commencement of another cutting action. The spring biasing means comprises a pair of coil springs 32 which are mounted one on each of the pair of guide rods 20.

The cutting blade 12 has a cutting edge 34 which extends at an angle to a longitudinal axis of the cutting blade 12.

The apparatus 2 includes mounting means 36 for mounting the apparatus 2 to a vertical support surface such for example as a wall.

As shown in FIG. 2, the holder 10 comprises a D-shaped column 38 which extends vertically with respect to the cutting station 8. The column 8 is positioned above the fruit 4. A front wall 40 of the column 8 may be supported on a cross member 42 forming part of the holder 10. Another cross member 44 is provided as shown. The two cross members 42, 44 are spaced apart and are being able to support a cover 46. The holder 10 is easily pulled off and pushed onto the remainder of the apparatus 2. This enables good cleaning access to the cutting station 8, and it also enables good access to the holder 10 for cleaning and/or fruit loading purposes.

FIG. 2 shows the cut slice 6 falling into a glass 48.

FIG. 3 shows how the cross members 42, 44 form part of a base 50 for the cover 46. The cover 46 is thus stably mounted and able to support the holder 10. Rods 52 extend from the base 50 to the mounting means 36 and thereby securely connect the mounting means 36 to the remainder of the apparatus 2.

FIG. 4 shows how the blade 12 has a bottom face which is provided with guide means in the form of two wedges 54. The wedges 54 act to guide the cut slice 6 away from the bottom face of the blade 12. This in turn acts to stop the cut slice 6 sticking to the bottom face of the blade 12.

The apparatus 2 is constructed from plastics materials for ease of cleaning. The blade 12 is usually made of stainless steel.

It will be appreciated that the apparatus 2 is able easily to be constructed. The component parts are relatively simple and thus manufacturing costs can be kept to the minimum. The apparatus 2 can be arranged such that the various parts easily separate for cleaning purposes. Thus, for example, the column 38 may be a simple push fit in position, so that it can be easily pulled off the remainder of the apparatus 2 to allow access to the parts underneath for cleaning purposes.

It is to be appreciated that the embodiment of the invention described above with reference to the accompanying drawings has been given by way of example only and that modifications may be effected. Thus, for example, the apparatus may be of a design different to that shown in the drawings. Also, the fruit 4 shown in the drawings is part of a lemon but it could equally well be part of an orange. The cutting station 8 and the holder 10 may be of a different design to take a whole fruit rather than part of a fruit. The design shown in the drawings is preferred because lemon slices are traditionally in the shape shown by the slice 6. Instead of mounting the apparatus vertically, the apparatus may have mounting means for mounting the apparatus on a horizontal work surface. After a cutting operation, the cutting blade 12 may be manually pulled back to its ready-for-use position, in which the coil springs 32 may be omitted.

1. Apparatus for cutting fruit into slices and dispensing the slices, which apparatus comprises a cutting station at which the fruit is cut into the slices, a holder which is for the fruit to be cut and which extends vertically above the cutting station, a cutting blade which extends at right angles to the holder and which is movable forwards and rearwards over the cutting station, and dispenser means for retaining the fruit to be cut at the cutting station and dispensing the cut slices, the dispenser means including a platform portion which supports the fruit to be cut at the cutting station and in the holder, the platform portion and the dispensing aperture being both provided in a flat member, the platform portion being positioned forwardly of the dispensing aperture, and the apparatus being such that the cutting blade is moved forwards over the cutting station by hand pushing in order to effect the cutting of the fruit into the slices, the cutting blade cuts the slices one at a time, and the dispenser means comprises a dispensing aperture through which the cut slices fall.

2. Apparatus according to claim 1 in which the cutting blade and the dispenser means are mounted on a movable support member.

3. Apparatus according to claim 2 in which the movable support member includes a pair of guide rods which are positioned one on either side of the apparatus, and which extend through guide apertures on either side of the apparatus.

4. Apparatus according to claim 2 in which the movable support member includes a handle for facilitating the forwards movement of the cutting blade.

5. Apparatus according to claim 1 in which the flat member is positioned below and spaced apart from the cutting blade, and in which the dispensing aperture is arranged to be beneath the fruit to be cut at the time when the cutting blade finishes its cutting action, whereby the cut slice is able to drop directly through the dispensing aperture.

6. Apparatus according to claim 1 in which the cutting blade is moved rearwards over the cutting station by spring biasing means.

7. Apparatus according to claim 3 in which the cutting blade is moved rearwards over the cutting station by a pair of coil springs mounted one on each of the pair of guide rods.

8. Apparatus according to claim 1 in which the cutting blade has a cutting edge which extends at an angle to a longitudinal axis of the cutting blade.

9. Apparatus according to claim 1 in which the cutting blade has a bottom face which is provided with guide means for guiding the cut slices away from the bottom face of the blade, whereby the cut slices are not able to stick to the bottom face of the blade.

10. Apparatus according to claim 9 in which the guide means comprises at least one wedge.

11. Apparatus according to claim 10 in which there are two of the wedges.

12. Apparatus according to claim 1 and including mounting means for mounting the apparatus to a vertical support surface.

13. Apparatus according to claim 1 in which the apparatus is constructed for being dismantled for washing purposes.
